(19) United States
(12) Patent Application Publication
(10) Pub. No.: US 2025/0042504 A1
(43) Pub. Date: Feb. 6, 2025

(54) METHOD FOR CONTROLLING A MOTIVE POWER UNIT, MOTIVE POWER UNIT AND PEDAL VEHICLE

(71) Applicant: E2 DRIVES, Wavre (BE)

(72) Inventors: Christophe DELEVAL, Bruxelles (BE); Jérôme ANTOONS, Luttre (BE)

(21) Appl. No.: 18/791,251

(22) Filed: Jul. 31, 2024

(30) Foreign Application Priority Data
Aug. 1, 2023 (BE) 2023/5641

(51) Int. Cl. B62M 6/55; B62M 6/45

(52) U.S. Cl. CPC B62M 6/55; B62M 6/45

(57) ABSTRACT

A method for controlling a motive power unit of a pedal vehicle propulsion assembly is disclosed. The method comprises interrupting and resuming pedaling by a user, calculating a first speed as a function of the speed of first and second motors, calculating a second speed at the defined point of the propulsion assembly as a function of a measurement of the vehicle speed, calculating a difference between the first and second speeds, controlling a first motor by a control unit, controlling the second motor with a torque setpoint lower in absolute value than the torque corresponding to the level of assistance when the difference between the first and second speeds is above a threshold, and controlling the second motor by the control unit with a torque setpoint corresponding to the level of assistance when the difference between the first and second speeds is below a threshold.

### CROSS-REFERENCE TO RELATED APPLICATION(S)

This present application claims priority to and the benefit of Belgium Patent Application No. BE2023/5641, filed Aug. 1, 2023, the disclosures of which are hereby incorporated by reference in their entireties.

### TECHNICAL FIELD

This disclosure relates to a method for controlling a motive power unit, a motive power unit and a pedal vehicle.

### BACKGROUND

Motive power units and motive power unit control methods are known in the prior art. For example, documents WO2013/160477, WO2016/034574, WO2019/043123 describe motive power units and control methods. Documents U.S. Pat. No. 5,375,676, WO2005/007439, EP30w68683 and U.S. Pat. No. 9,546,731 also describe motive power units and control methods, but the operation of the motive power units is unsatisfactory and the method for controlling the motive power units does not allow to smoothly resume the pedaling.

### SUMMARY

To this end, a method for controlling a motive power unit of a pedal vehicle propulsion assembly is disclosed, the motive power unit comprising:

A differential system comprising a first input element, a second input element and an output element,

A first motor connected to the first input element,

A second motor connected to the differential system,

A control unit configured to control the first motor according to a speed setpoint and configured to control the second motor according to a torque setpoint corresponding to a level of assistance,

An input body driven by a bottom-bracket, the input body being connected to the second input element of the differential system,

An output body driven in rotation by the output element of the differential system,

A freewheel between the output element of the differential system and a rear wheel of the pedal vehicle, the freewheel is able to couple or uncouple the rear wheel and the bottom-bracket, the method comprising

interrupting of the pedaling and then resuming of the pedaling by the cyclist,

calculating a first speed at a defined point of the propulsion assembly, downstream of the differential system, as a function of the speed of the first motor and of the second motor,

calculating a second speed at the defined point of the propulsion assembly as a function of a measurement of the speed of the vehicle, calculating the difference between the first speed and the second speed,

controlling the first motor by the control unit, with the control unit controlling the first motor at speed,

controlling the second motor by the control unit with a torque setpoint lower in absolute value than the torque corresponding to the level of assistance when the difference between the first speed and the second speed is above a certain threshold,

controlling the second motor by the control unit with a torque setpoint corresponding to the level of assistance only when the difference between the first speed and the second speed is below a certain threshold.

According to a variant, when the difference between the first speed and the second speed is above a certain threshold, the torque setpoint is zero torque.

According to a variant, the control of the first motor is adapted to accelerate the reduction of the deviation between the speed setpoint and the actual value of the speed of the first motor.

In one variant, the second speed is calculated by the control unit using one or more wheel sensors of the vehicle.

According to a variant, the first speed of the vehicle is calculated by the control unit on the basis of the speeds of rotation of the first motor and of the second motor.

According to a variant, the resuming of the pedaling corresponds to the moment when the cyclist again applies an action to the bottom-bracket.

According to a variant, the differential system of the motive power unit is selected from the group comprising:

an epicyclic gear train with a sun gear, a ring gear and a planet carrier, the first input element being the sun gear, the second input element being the ring gear and the output element being the planet carrier, or the second input element being the planet carrier and the output element being the ring gear,

a cycloidal gear train with a ring gear, an excitation eccentric, a wheel, transfer eccentrics and a transfer eccentric carrier, the first input element being the excitation eccentric, the second input element being the ring gear and the output element being the transfer eccentric carrier, or the second input element being the transfer eccentric carrier and the output element being the ring gear,

a cycloidal gear train comprising a ring gear, an excitation eccentric, a double-toothing wheel and a pinion, the first input element being the excitation eccentric, the second input element being the ring gear and the output element being the pinion, or the second input element being the pinion and the output element being the ring gear,

a harmonic gear train comprising a ring gear, a wave generator, a flexible wheel, the first input element being the wave generator, the second input element being the ring gear and the output element being the flexible wheel, or the second input element being the flexible wheel and the output element being the ring gear.

According to a variant, the difference between the first speed and the second speed provides information about the coupling or uncoupling state of the freewheel.

According to a variant, the second motor is connected to the second input element of the differential system or to the output element of the differential system.

According to a variant, the bottom-bracket is connected to the second input element.

The disclosure also relates to a motive power unit for a pedal vehicle, the motive power unit being suitable for implementing the method as previously described.

The disclosure also relates to a pedal vehicle, comprising the propulsion assembly comprising the motive power unit as described above.

In one embodiment, the vehicle comprises a bottom-bracket, with the geared motor unit located on the bottom-bracket.

According to a variant, the vehicle comprises at least one rear wheel, the geared motor unit being level with the axis of rotation of the rear wheel.

In the context of this document, the successive indication of method steps does not necessarily mean that the steps occur one after the other, but possibly in parallel.

In the context of this document, two connected or linked elements may be connected or linked directly or indirectly. They may, for example, be directly or indirectly meshed via at least one intermediate toothed wheel, a belt and/or a roller.

For the purposes of this document, the terms “input” and “output” are to be understood in the sense of an input and an output in the kinematic chain that is the propulsion assembly. An input may be a mechanical power input and an output may be a mechanical power output.

In the context of this document, a gear element may, for example, be a toothed wheel or a plurality of toothed wheels mechanically coupled or meshed together.

For the purposes of this document, an element “arranged to rotate about an axis of rotation” may be an element that is substantially symmetrical about that axis.

In the context of this document, a “fixed ratio” between two objects or elements means that their rotational speeds are in a constant ratio.

In the context of this document, the “motive power unit speed ratio” refers to the speed ratio existing between an output body and an input body.

For the purposes of this document, “motive power unit assistance level” refers to the portion of power given by the electric assistance compared to the power given by the cyclist. It may be calculated as the power of the assembly of the two motors divided by the sum of the power of the assembly of the two motors and of the power of the cyclist. It may also be referred to as “assistance level parameter”. This is a parameter that may be controlled manually by the cyclist via a control interface or calculated automatically by the control unit based on other parameters.

For the purposes of this document, an angular position measurement is equivalent to an angular velocity measurement. The motive power unit may comprise a mechanism for determining the angular speed of one of the motors from the angular position of that motor. There is no fundamental difference between a control at position and a control at speed because there is a direct mathematical link between the two values. The angular speed is the time derivative of the angular position. For example, controlling a motor to rotate at a constant angular speed is equivalent to controlling a motor to follow an angular position that changes linearly with time.

For the purposes of this document, a current measurement is equivalent to a torque measurement. More specifically, measuring the current in the phases of a motor is equivalent to measuring torque. The motive power unit may comprise a mechanism for determining the torque of one of the motors from the current supplied to that motor.

In the context of this document, the terms “upstream” and “downstream” should be understood in the sense that an upstream element is closer to the power source and a downstream element is closer to an output driven element.

The use of the verb “comprise” and its variants, as well as its conjugations in this document, may not in any way exclude the presence of elements other than those mentioned. The use in this document of the indefinite article “a”, “an”, or the definite article “the” to introduce an element does not exclude the presence of a plurality of these elements.

The terms “first”, “second”, “third”, etc. are used in this scope of this document exclusively to differentiate between different elements, without implying any order between these elements.

All the embodiments and all the advantages of the motive power unit control method according to the disclosure apply mutatis mutandis to the present motive power unit and to the vehicle, and vice versa. The various embodiments may be considered individually or in combination.

### BRIEF DESCRIPTION OF THE DRAWINGS

Further characteristics and advantages of the disclosed subject matter will become apparent from the following detailed description, for the understanding of which reference is made to the attached figures which show:

FIG. 1, an example of a functional view of a propulsion assembly wherein the method is implemented;

FIG. 2, a detailed functional view of FIG. 1;

FIG. 3 shows another detailed functional view of FIG. 1.

The drawings in the figures are not to scale. Similar elements are generally denoted by similar references in the figures. In the scope of this document, the same or similar elements may have the same references. Furthermore, the presence of reference numbers or letters in the drawings may not be considered as limiting, even when these numbers or letters are indicated in the claims.

### DETAILED DESCRIPTION

The disclosure relates to a method for controlling a motive power unit of a pedal vehicle propulsion assembly, the motive power unit comprising a first motor and a second motor, the second motor being an assist control motor. In particular, the method comprises a step of interrupting of the pedaling and then resuming of the pedaling by a user, a step of calculating a first speed at a defined point of the propulsion assembly, downstream of the differential system, as a function of the speed of the first motor and of the second motor a step of calculating a second speed at the defined point of the propulsion assembly as a function of a measurement of the speed of the vehicle, a step of calculating a difference between the first speed and the second speed, a step for controlling a first motor of the motive power unit by a control unit, the control unit controlling the first motor at speed. The method also comprises a step wherein the second motor is controlled by the control unit with a torque setpoint lower in absolute value than the torque corresponding to the level of assistance when the difference between the first speed and the second speed is above a certain threshold, and a step wherein the second motor is controlled by the control unit with a torque setpoint corresponding to the level of assistance only when the difference between the first speed and the second speed is below a certain threshold. This allows you to resume the pedaling comfortably and to reach the desired gear ratio as smoothly as possible.

The method according to the disclosure differs from the prior art implements a calculation of several speeds (as a function of other criteria) at a single point, called the defined point. In the prior art, the definition of such a point is not provided. The method also targets a particular moment in the use of the pedal vehicle, namely the resuming of the pedaling. The control method involves resuming the pedaling in two phases. The method involves delaying the application of a torque corresponding to the level of assistance required by the user in a first phase (or transitional phase), before applying the torque corresponding to the required level of assistance in a second phase. During the first phase, the second motor is not controlled with the torque setpoint corresponding to the level of assistance required by the user, even though the user has requested a level of assistance. In other words, during the first phase, the second motor is controlled with a torque setpoint different from that corresponding to the level of assistance actually required by the user. In the second phase is the second motor controlled with the torque setpoint corresponding to the level of assistance required by the user. So the disclosure is not necessarily aimed at a generic control of two motors, but at a two-phase resuming of the pedaling allowing a pleasant resuming of the pedaling and the achievement of the desired gear ratio in the smoothest possible way.

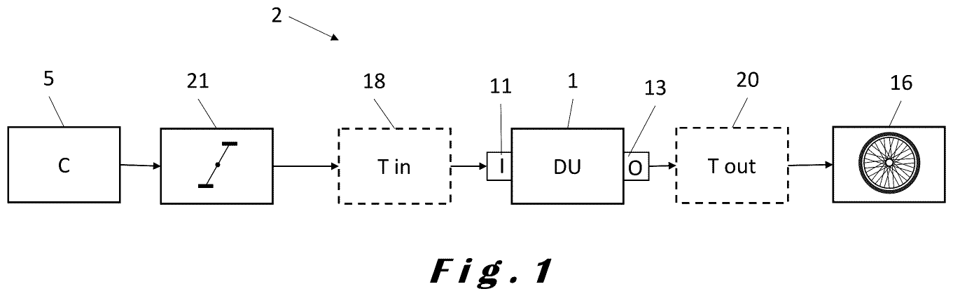

FIG. 1 is an example of a functional view of a propulsion assembly 2 wherein the method is implemented. The propulsion assembly 2 is applied to a pedal vehicle. The propulsion assembly 2 is diagrammed between a cyclist 5 (C) and a rear wheel 16 (with an angular velocity ωW). The pedal vehicle may be a bicycle, a tricycle or other. These include bicycles, tricycles and other electrically-assisted vehicles. The propulsion assembly 2 comprises a bottom-bracket 21 (comprising pedals) operated by the cyclist 5. The bottom-bracket allows the cyclist to drive the vehicle with or without the assistance regulation of the electric motors described below. The propulsion assembly 2 comprises a motive power unit 1 (DU) which may be located at the level of the bottom-bracket 21 (middrive propulsion assembly 2). The motive power unit 1 may be located in other positions. For example, the motive power unit 1 may be located in the hub of a rear wheel 16 of the vehicle (hub drive propulsion assembly). In other cases, for example two-wheeled cargo vehicles, tricycles or quadricycles, the motive power unit 1 may be between the bottom-bracket and the axle of the rear wheels of the vehicle.

The motive power unit 1 may comprise an input body 11 and an output body 13. The bottom-bracket 21 may be confused with the input body 11 of the motive power unit 1. Alternatively, the output body 13 may be coincident with the rim of the wheel 16.

The propulsion assembly 2 may comprise an upstream transmission 18 (Tin) between the bottom-bracket 21 and the input body 11 of the motive power unit 1. The upstream transmission 18 connects the bottom-bracket 21 and the input body 11 together. The upstream transmission 18 may be a chain, a belt or any type of transmission element. The upstream transmission may change the angular velocity ωCK of the bottom-bracket (or bottom-bracket axle) into an angular velocity ω1. The upstream transmission 18 may be optional.

The propulsion assembly 2 may comprise a downstream transmission 20 (All) between the output body 13 of the motive power unit 1 and one or more rear wheels 16 of the vehicle. The downstream transmission 20 connects the output body 13 and one or more rear wheels 16 together. The downstream transmission may modify the angular speed ωO of the output body 13 into an angular speed ωTO. The downstream transmission 20 may be optional.

Thus, in the middrive type propulsion assembly 2 of a vehicle with a motive power unit 1 located at the level of the bottom-bracket 21, the bottom-bracket 21 may be merged with the input body 11 (and therefore the upstream transmission 18 absent) and the downstream transmission 20 may be a chain or a belt connecting the output body 13 of the motive power unit 1 to the rear wheel. In the hub drive type propulsion assembly 2, the upstream transmission 18 may be a chain or belt connecting the bottom-bracket 21 and the input body 11 of the motive power unit 1 and the output body 13 may be merged with the rim of the rear wheel 16 (and therefore the downstream transmission 20 absent). Alternatively still, the upstream transmission 18 may be a first chain or a belt (or any other type of transmission element) connecting the bottom-bracket 21 to the input body 11 of the motive power unit 1 and the downstream transmission 20 may be a chain or a belt (or any other type of transmission element) connecting the output body 13 of the motive power unit 1 to the rear wheel 16. This configuration of propulsion assembly could be used in certain specific bicycles, referred to as the cargo bikes.

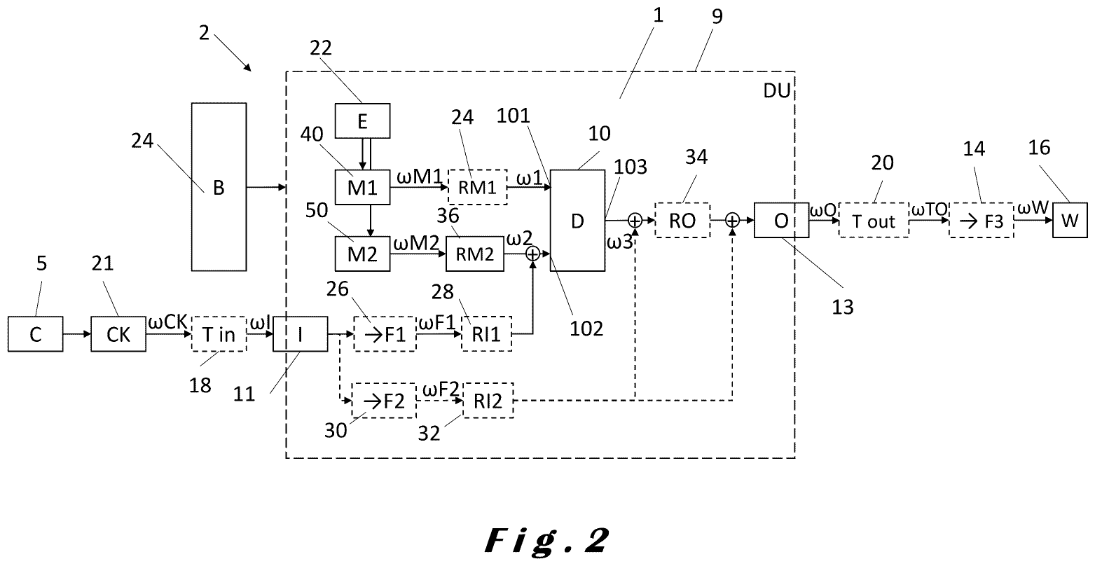

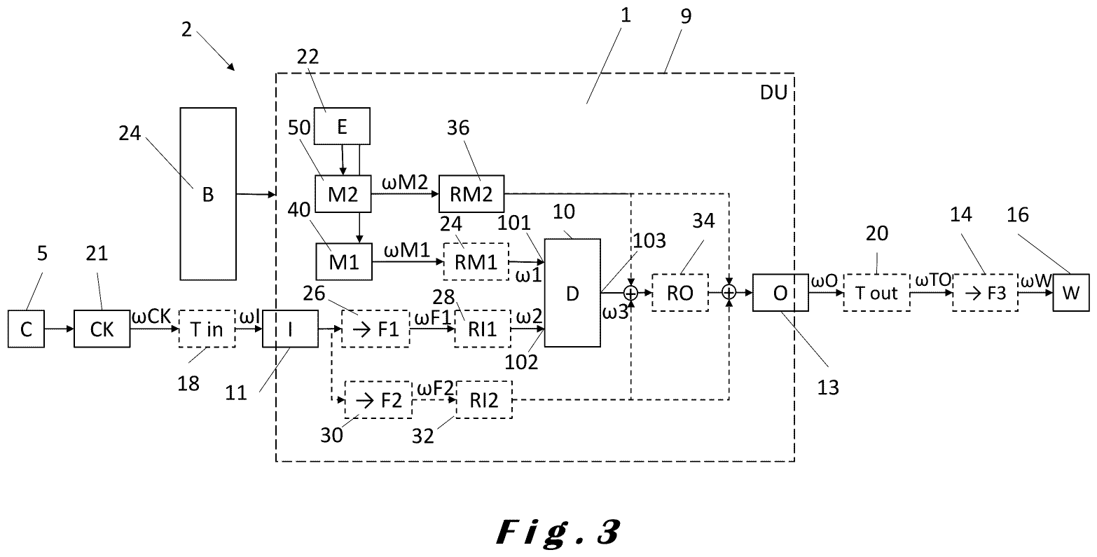

FIGS. 2 and 3 show different detailed functional views of FIG. 1. The motive power unit 1 comprises a first motor 40 (M1) and a second motor 50 (M2). The motive power unit 1 may comprise a current measurement element of the first motor 40 and a current measurement element of the second motor 50. The motive power unit 1 also comprises a control unit 22. The control unit 22 is connected to the first motor 40, to the second motor 50 and is arranged to control the first motor and the second motor. The angular position of the first motor and of the second motor may be determined by measuring elements. The measuring elements are, for example, magnets rotating on the motor shafts opposite magnetic sensors, or more generally any type of optical or magnetic encoder, etc. The control unit 22 controls the first motor 40 and the second motor 50 on the basis of the angular position of the first motor 40, the angular position of the second motor 50, the current of the first motor 40 and the current of the second motor 50, this information having been supplied to it by the measurement elements. The control unit 22 may control the first motor 40 at angular position or at angular speed. The control unit 22 preferably controls the second motor 50 at current or torque.

In one particular implementation, the propulsion assembly 2 comprises one or more batteries 24 supplying electricity to any object or element of the propulsion assembly 2 or, more specifically, of the motive power unit 1 that requires it, such as the motors 40, 50, the control unit 22, sensors, etc.

The role of the first motor 40 may be to control the speed ratio of the motive power unit 1. One of its functions is to offer a given transmission ratio. This transmission ratio is the ratio between the angular speed of the output body 13 of the motive power unit 1 and the angular speed of the input body 11 of the motive power unit 1. This gear ratio may, for example, be determined on the basis of a gear ratio parameter provided by the cyclist or be determined by the control unit 22 in order to offer the cyclist an automatic gear change. In particular, this determination may be made using a gear shifting algorithm. The first motor 40 may be controlled at angular position or at angular speed, for example via the control unit 22 which controls the first motor in such a way that an angular position or angular speed setpoint is complied with.

The role of the second motor 50 may be to manage the correct level of assistance regulation for the motive power unit. One of its functions is to assist the movement of the cyclist by adding torque to that supplied by the cyclist and the first motor. In other words, the power supplied by the second motor is added to the power supplied by the cyclist and by the first motor. The level of assistance may be determined by the control unit 22 based in particular on an assistance level parameter. The assistance level parameter may be determined by the cyclist or automatically by the control unit 22 of the motive power unit. The second motor controlled at current or torque, for example via the control unit 22, which controls the second motor in such a way that a current or torque setpoint is complied with. In addition, the control unit 22 may control the second motor according to a torque setpoint with a regulation.

The motive power unit combines an electric assistance and an automatic gearbox. The motive power unit provides a continuously variable transmission ratio.

The control unit 22 may be arranged to determine a rotation speed setpoint and to impose said rotation speed setpoint on the first motor 40, the rotation speed setpoint being determined as directly proportional to the rotation speed of the input body 11 obtained by calculation on the basis of the angular position of the first motor 40 and/or of the second motor 50 and the speed ratio parameter. The control unit 22 may also rely on the speed ratio parameter and the motive power unit assistance level parameter to control the second motor 50. The control unit 22 may be arranged to determine a current or torque setpoint and to impose said current or torque setpoint on the second motor 50. The current or torque setpoint of the second motor is determined by taking into account one or more criteria, including the torque or the current of the first motor obtained by the current measuring element of the first motor, the speed of the first motor, the speed of the second motor, the speed ratio parameter of the motive power unit and the assistance level parameter of the motive power unit.

The motive power unit 1 may also comprise a differential system 10 (D). The use of a differential system 10 allows a change in the continuous speed ratio between the rotation of the output body 13 and the rotation supplied by the cyclist to the input body 11. The differential system 10 may comprise a first input element 101 (with an angular velocity ω1), a second input element 102 (with an angular velocity ω2) and an output element 103 (with an angular velocity ω3).

The input body 11 may be connected to the second input element 102 of the differential system 10. The input body 11 transmits the power supplied by the cyclist to the input of the differential system 10. The input body 11 may drive the second input element 102, e.g., with a stationary ratio. The input body 11 may be connected indirectly to the second input element 102 by means of a first freewheel 26 (F1). The function of the freewheel 26 is that the bottom-bracket 21 may drive the input element 102 of the differential system but the second motor 50 may not drive the bottom-bracket 21. The input body 11 may be connected indirectly to the second input element 102 by means of a reducer 28 (RI1), modifying the angular speed ωF1 of the first freewheel 26. Alternatively, the input body 11 may be connected directly to the second input element 102-a connection establishing the link between the input body 11 and the second input element 102.

The input body 11 may be connected indirectly to the output body 13 by means of a second freewheel 30 (F2). The input body 11 transmits the power supplied by the cyclist to the output of the motive power unit 1. This allows the cyclist, for example, to move the pedal vehicle forward without the intervention of the motors 40, 50-advantageous in the event of a motor failure. The input body 11 may be connected indirectly to the output body 13 by means of a reducer 32 (RI2), modifying (i.e. multiplying or reducing) the angular speed ωF2 of the second freewheel 30. The input body 11 may be connected indirectly to the output body 13 by means of a reducer 34 (RO).

The first motor 40 may be connected to the first input element 101 of the differential system 10. The first motor 40 may drive the first input element 101, e.g., with a stationary ratio. The first motor 40 is then used to control the speed ratio of the motive power unit 1. The first motor 40 may be connected indirectly to the first input element 101 by means of a reducer 24 (RM1). The reducer 24 changes the angular speed ωM1 of the first motor 40 to an angular speed ω1. Alternatively, the first motor 40 may be connected directly to the first input element 101, without the reducer 24, the angular speed ωM1 of the first motor 40 corresponding to the angular speed ω1.

The second motor 50 may be connected to the second input element 102 of the differential system 10 (as shown in FIG. 2). The second motor 50 may drive the second input element 102, e.g., with a stationary ratio. The second motor 50 is used to control the correct level of assistance regulation from the input to the differential system 10. The second motor 50 may be connected indirectly to the second input element 102 by means of a reducer 36 (RM2). The reducer 36 modifies (i.e. multiplies or reduces) the angular speed ωM2 of the second motor 50.

The second motor 50 may also be connected to the output body 13 of the motive power unit 1. The second motor 50 may drive the output body 13, e.g., with a stationary ratio. The second motor 50 is used to control the correct level of assistance regulation from the output of the differential system 10. The second motor 50 may be connected indirectly to the output body 13 by means of the reducer 36 (RM2). The reducer 36 modifies (i.e. multiplies or reduces) the angular speed ωM2 of the second motor 50. The reducer is used to reduce the torque from the second motor. The second motor 50 may also be connected indirectly to the output body 13 by means of the reducer 34 (RO).

Thus, on the second input element of the differential system 10, the angular velocity ω2 may be an angular velocity coming from the bottom-bracket 21 (FIG. 3) or be an angular velocity coming from the bottom-bracket 21 equal (because mechanically connected) to that coming from the second motor 50 (FIG. 2).

The propulsion assembly 2 may also comprise a third freewheel 14 (F3). The third freewheel 14 may be located between the bottom-bracket 21 and a rear wheel 16 of the pedal vehicle, the freewheel being able to couple (synchronize) or uncouple (desynchronize) the rear wheel and the bottom-bracket. The freewheel allows pedaling to be interrupted (and the rotation of the bottom-bracket axle 21 to be interrupted) while allowing the vehicle to continue moving. The freewheel is located, for example, between the output element 103 of the differential system and the rear wheel 16. The freewheel 14 is located, for example, downstream of the output body 13. The freewheel 14 is located downstream of the downstream transmission 20, for example. The third freewheel 14 is located, for example, in the hub of the rear wheel.

The differential system 10 may, for example, be an epicyclic gear train. The epicyclic gear train comprises a planetary gear, a ring gear and a planet carrier and one or more planet gears, carried by the planet carrier, between the planetary gear and the ring gear. The first input element 101 may be the sun gear. The second input element 102 may be the ring gear and the output element 103 may be the planet carrier. Alternatively, the second input element 102 may be the planet carrier and the output element 103 may be the ring gear.

The differential system 10 may also be, for example, a cycloidal gear train. In a first version, the cycloidal train comprises a ring gear, an excitation eccentric, a wheel, transfer eccentrics and a transfer eccentric carrier. The first input element may be the excitation eccentric. The second input element may be the ring gear and the output element may be the transfer eccentric carrier. Alternatively, the second input element may be the transfer eccentric carrier and the output element may be the ring gear.

In a second version, the cycloidal gear train comprises a ring gear, an excitation eccentric, a wheel (with double toothing) and a pinion. The first input element may be the excitation eccentric. The second input element may be the ring gear wheel and the output element may be the pinion. Alternatively, the second input element may be the pinion and the output element may be the ring gear.

The differential system 10 may also be, for example, a harmonic train. The harmonic train comprises a ring gear, a wave generator and a flexible wheel. The first input element may be the wave generator. The second input element may be the ring gear and the output element may be a flexible wheel. Alternatively, the second input element may be the flexible wheel and the output element may be the ring gear.

The motive power unit 1 may be housed in a housing 9. The input body 11 and the output body 13 may mark the interfaces between the inside and the outside of the housing 9. The motors 40, 50, the differential system 10, the control unit 22, etc. may be housed in the housing 9 so as to protect them from the environment. The motive power unit combines an electric assistance and an automatic gearbox in a single housing.

For example, the first motor 40 and second motor 50 may be controlled as follows.

When using the vehicle, the cyclist may drive the vehicle by pedaling (and being assisted by the first and second motors, which add torque to that supplied by the cyclist) and may stop pedaling while the vehicle continues to move, freewheeling. When pedaling stops, the first motor 40 and the second motor 50 stop-possibly to a standstill, depending on the duration of the pedaling interruption and the inertia of the respective rotors. When pedaling is resumed, the first motor 40 accelerates rapidly from a standstill to its speed setpoint controlled by the control unit 22. This is particularly the case at high speeds and/or high gear ratios. This sudden acceleration requires high instantaneous power PM1. If the level of assistance provided AF (corresponding to the assistance power divided by the cyclist's power) provided by the second motor 50 is low (by choice or by constraint), the second motor 50 may have to brake to provide the level of assistance. This phenomenon may be illustrated by the following calculation. The calculation, given for illustrative purposes, makes certain assumptions. With Preq the required power, PM2 the power of the second motor 50, Pmot the sum of the powers of the two motors 40, 50 and Pcycl the power of the user cyclist: Preq=Pcycl* (1+AF).

If we want to satisfy Preq we have: Preq=Pcycl+Pmot
So: Pmot=PM1+PM2=Pcycl*AF
If PM1>Pcycl*AF, then PM2<0

An example which illustrates this problem is that in the case of zero assistance, AF=0. In this case, PM2=−PM1. The fact that the first motor 40 accelerates rapidly from standstill to its speed setpoint means that the second motor 50 has to brake-which is accentuated at high speeds and/or high gear ratios. This is unpleasant for the cyclist, because the moment the cyclist starts to resume pedaling when the bike is already moving, he expects zero resistance because he still has to “catch up” with the freewheel. If nothing is done to mitigate or avoid this phenomenon, the cyclist will feel the bottom-bracket lock up for a short time, until the first motor 40 reaches its speed setpoint.

Thus, when pedaling is resumed by the cyclist after pedaling has been interrupted (while the vehicle is in motion), the method comprises a step of controlling the first motor 40 by the control unit 22, the control unit 22 controlling the first motor 40 at speed. In parallel, or simultaneously, the method comprises calculating a first speed A at a defined point of the propulsion assembly, as a function of the speed of the first motor 40 and of the second motor 50, as well as calculating a second speed B at the defined point of the propulsion assembly as a function of a measurement of the speed of the vehicle. The speeds A and B are calculated at the same point, which is said defined point.

The point defined may be downstream of the differential system 10. In other words, along the propulsion assembly 2, the point defined is after the differential system, or in other words after the output element 103 of the differential system 10.

The defined point may be, for example, between the output element 103 and the reducer 34 (which corresponds, for example, to the calculation of ω3), between the reducer 34 and the output body 13, between the output body 13 and the downstream transmission 20 (which corresponds, for example, to the calculation of ωO), between the downstream transmission 20 and the freewheel 14 (which corresponds, for example, to the calculation of ωTO) or, alternatively, between the freewheel 14 and the rear wheel 16 (which corresponds, for example, to the calculation of ωW).

The calculation of the first speed A and the calculation of the second speed B (by the control unit 22) are made according to the characteristics of the elements-connected or linked together-described above, forming a kinematic chain of the propulsion assembly.

The first speed A is effectively calculated when the point defined is upstream of the freewheel 14, between the output element 103 and the freewheel 14. The first speed A is calculated fictitiously (or extrapolated) when the point defined is downstream of the freewheel 14, between the freewheel 14 and the rear wheel 16, because in this case the calculation is performed on the assumption that the freewheel 14 transmits the movement along the kinematic chain (coupled state). The second speed B is effectively calculated when the point defined is downstream of the freewheel 14, between the freewheel 14 and the rear wheel 16. The second speed B is calculated fictitiously (or extrapolated) when the point defined is upstream of the freewheel 14, between the output element 103 and the freewheel 14. This is because in this case the calculation is performed on the assumption that the freewheel 14 transmits the movement along the kinematic chain (coupled state). So, when calculating the first speed A and the second speed B, one will be calculated effectively and the other fictitiously-depending on the position of the defined point.

The method also comprises calculating a difference between the first speed A and the second speed B. The difference provides information (in particular to the control unit 22) about the state of the freewheel 14. If the difference is zero, the freewheel 14 transmits the movement (of the propulsion assembly) towards the rear wheel. This corresponds to a coupling (or synchronization) state. If the difference is not zero, the freewheel 14 interrupts the movement (of the propulsion assembly) towards the rear wheel. This corresponds to an uncoupling (or desynchronization) state.

The method also comprises a step of controlling the second motor 50 with a torque setpoint lower in absolute value than the torque corresponding to a level of assistance when the difference between the first speed A and the second speed B is above a certain threshold (the torque of the setpoint is lower in absolute value than the torque corresponding to a level of assistance). The method also comprises a step of controlling the second motor 50 by the control unit 22 with a torque setpoint corresponding to a level of assistance only when the difference between the first speed A and the second speed B is below a certain threshold. In this way, the motive power unit control method allows that the second motor 50 is not necessarily servo-controlled to the required level of assistance while the first motor 40 accelerates to reach its speed setpoint. During this first phase—or transitional phase—the second motor is not necessarily servo-controlled to the required level of assistance. It is only when the first motor 40 approaches, or even reaches, its speed setpoint that the control method servo-control the second motor 50 to the required level of assistance. When the difference between the first gear A and the second gear B is below the threshold, the motive power unit switches to normal operating mode, with assistance regulated by the second motor in line with the rider's wishes. During this second phase, the second motor is servo-controlled with the required level of assistance. This servo-control is therefore delayed when the pedaling is resumed. This allows to reduce or even prevent the second motor 50 from braking. This allows to reduce or eliminate the discomfort caused by the sensation of the bottom-bracket locking up when the pedaling is resumed.

The resuming of the pedaling corresponds to the moment when the cyclist again applies an action to the bottom-bracket 21—in particular the pedals—while the vehicle is in motion. The resuming of the pedaling begins a transitional phase that will resynchronize/couple the bottom-bracket and one of the rear wheels.

The threshold below or above which the second motor is controlled with the torque setpoint corresponding to the required level of assistance may be determined in several ways. By way of example, the threshold is determined as follows. The threshold may be stationary. The threshold may be determined on the basis of the accuracy of the speed measurement elements (such as a speed sensor) and fine-tuning (by a calibrator for example) to improve the cyclist's feeling when the pedaling is resumed. The threshold may also be variable. The threshold may be determined on the basis of these same elements, the acceleration of the first motor or the upstream and/or downstream transmission (at what speed the freewheel is caught up), and the speed of the vehicle.

In addition to taking into account the characteristics of the elements of the propulsion assembly 2 according to the position of the defined point, the first speed A is established, calculated by the control unit 22 on the basis of the speeds of rotation of the first motor 40 and of the second motor 50.

In addition to taking into account the characteristics of the elements of the propulsion assembly 2 according to the position of the defined point, the second speed B is calculated by the control unit 22 using one or more elements for measuring the speed of the vehicle, such as vehicle wheel sensors. The sensor or sensors on one or more of the wheels of the vehicle provide the control unit 22 with information allowing the actual speed of the vehicle to be calculated. Other means are also possible, such as by changing the GPS position.

By way of example, when the difference between the first speed A and the second speed B is above a certain threshold, the torque setpoint is zero torque. This makes for a particularly pleasant resuming of the pedaling and ensures that you reach the gear ratio you want as smoothly as possible. Values of the torque setpoint other than zero torque are possible, between zero and a value lower in absolute value than the torque corresponding to the level of assistance, as long as the resuming of the pedaling is pleasant and reaching the desired gear ratio is smooth.

The method may further comprise a control of the first motor adapted to accelerate the reduction of the deviation between the speed setpoint and the actual value of the speed of the first motor. This allows to reduce the time during which the control of the second motor is with a torque setpoint lower in absolute value than the torque corresponding to the level of assistance. This allows you to resume the pedaling comfortably and reach the desired gear ratio as quickly and smoothly as possible. Moreover, when the pedaling is resumed, particularly at high speed, the chain takes some time to catch up with the rear wheel, which may feel like pedaling in a vacuum to the cyclist. By catching up to the setpoint speed more quickly, you reduce the feeling of pedaling in a vacuum when you resume. Even though the duration of the first phase—or transitional phase—may be variable, the method may allow it to be shortened according to this non-limiting embodiment.

For example, this may be achieved by the control unit 22 controlling the first motor with a higher speed setpoint value than the target speed setpoint value. Alternatively, the proportional gain of the first motor's control law is momentarily higher than the proportional gain in normal operating mode. The method may be implemented by the control unit 22.

The disclosure relates to a method for controlling the motive power unit, a motive power unit configured to implement the method and a pedal vehicle comprising the motive power unit.

As the method relates to the control of the motive power unit, the method then also relates to the control of the propulsion assembly comprising the motive power unit and also to the control of the pedal vehicle comprising the propulsion assembly. The disclosure may also relate to the propulsion assembly comprising the motive power unit. The various embodiments and all the advantages described apply to them.

The disclosed subject matter has been described above in connection with specific embodiments, which are illustrative and should not be considered limiting. In general, it will be apparent to a person skilled in the art that the disclosure is not limited to the examples illustrated and/or described above.

1. A method for controlling a motive power unit of a pedal vehicle propulsion assembly, the motive power unit comprising:
a differential system comprising a first input element, a second input element and an output element;
a first motor connected to the first input element;
a second motor connected to the differential system;
a control unit configured to control the first motor according to a speed setpoint and configured to control the second motor according to a torque setpoint corresponding to a level of assistance;
an input body driven by a bottom-bracket, the input body being connected to the second input element of the differential system;
an output body driven in rotation by the output element of the differential system;
a freewheel between the output element of the differential system and a rear wheel of the pedal vehicle, the freewheel is configured to couple or uncouple the rear wheel and the bottom-bracket;
the method comprising:
interrupting of the pedaling and then resuming of the pedaling by a cyclist;
calculating a first speed at a defined point of the propulsion assembly, downstream of the differential system, as a function of the speed of the first motor and of the second motor;
calculating a second speed at the defined point of the propulsion assembly as a function of a measurement of the speed of the vehicle;
calculating the difference between the first speed and the second speed;
controlling the first motor by the control unit, the control unit controlling the first motor at speed, controlling the second motor by the control unit with a torque setpoint lower in absolute value than the torque corresponding to the level of assistance when the difference between the first speed and the second speed is above a certain threshold; and
controlling the second motor by the control unit with a torque setpoint corresponding to the level of assistance only when the difference between the first speed and the second speed is below a certain threshold.

2. The method according to claim 1, wherein when the difference between the first speed and the second speed is above a certain threshold, the torque setpoint is zero torque.

3. The method according to claim 1, wherein the control of the first motor is adapted to accelerate a reduction of a deviation between the speed setpoint and the actual value of the speed of the first motor.

4. The method according to claim 1, wherein the second speed is calculated by the control unit using one or more wheel sensors of the vehicle.

5. The method according to claim 1, wherein the first speed of the vehicle is calculated by the control unit on a basis of the speeds of rotation of the first motor and of the second motor.

6. The method according to claim 1, wherein the resuming of the pedaling corresponds to a moment when the cyclist again applies an action to the bottom-bracket.

7. The method according to claim 1, the differential system of the motive power unit is selected from a group comprising:
an epicyclic gear train with a sun gear, a ring gear and a planet carrier, the first input element being the sun gear, the second input element being the ring gear and the output element being the planet carrier, or the second input element being the planet carrier and the output element being the ring gear;
a cycloidal gear train with a ring gear, an excitation eccentric, a wheel, transfer eccentrics and a transfer eccentric carrier, the first input element being the excitation eccentric, the second input element being the ring gear and the output element being the transfer eccentric carrier, or the second input element being the transfer eccentric carrier and the output element being the ring gear;
a cycloidal gear train comprising a ring gear, an excitation eccentric, a double-toothing wheel and a pinion, the first input element being the excitation eccentric, the second input element being the ring gear and the output element being the pinion, or the second input element being the pinion and the output element being the ring gear; and
a harmonic gear train comprising a ring gear, a wave generator, a flexible wheel, the first input element being the wave generator, the second input element being the ring gear and the output element being the flexible wheel, or the second input element being the flexible wheel and the output element being the ring gear.

8. The method according to claim 1, wherein the difference between the first speed and the second speed provides information about the coupling or uncoupling state of the freewheel.

9. The method according to claim 1, the second motor being connected to the second input element of the differential system or to the output element of the differential system.

10. The method according to claim 1, the bottom-bracket being connected to the second input element.

11. A pedal vehicle comprising:
a propulsion assembly having a motive power unit, the motive power unit including:
a differential system comprising a first input element, a second input element and an output element;
a first motor connected to the first input element;
a second motor connected to the differential system;
a control unit configured to control the first motor according to a speed setpoint and configured to control the second motor according to a torque setpoint corresponding to a level of assistance;
an input body driven by a bottom-bracket, the input body being connected to the second input element of the differential system;
an output body driven in rotation by the output element of the differential system,
a freewheel between the output element of the differential system and a rear wheel of the pedal vehicle, the freewheel is configured to couple or uncouple the rear wheel and the bottom-bracket;
the motive power unit including a control unit configured to, in response to interrupting of the pedaling and then resuming of the pedaling by the cyclist:
calculate a first speed at a defined point of the propulsion assembly, downstream of the differential system, as a function of the speed of the first motor and of the second motor;
calculate a second speed at the defined point of the propulsion assembly as a function of a measurement of the speed of the vehicle;
calculate the difference between the first speed and the second speed;
control the first motor by the control unit, the control unit controlling the first motor at speed;
control the second motor by the control unit with a torque setpoint lower in absolute value than the torque corresponding to the level of assistance when the difference between the first speed and the second speed is above a certain threshold; and
control the second motor by the control unit with a torque setpoint corresponding to the level of assistance only when the difference between the first speed and the second speed is below a certain threshold.

12. The vehicle according to claim 11, further comprising a bottom-bracket and a geared motor unit at the level of the bottom-bracket.

13. The vehicle according to claim 12, comprising at least one rear wheel, wherein the geared motor unit is at the level of an axis of rotation of the rear wheel.
